(19) United States
(12) Patent Application Publication
(10) Pub. No.: US 2010/0098526 A1
(43) Pub. Date: Apr. 22, 2010

(54) AIRFOIL WITH COOLING PASSAGE PROVIDING VARIABLE HEAT TRANSFER RATE

(76) Inventor: Justin D. Piggush, Hartford, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/252,514

(22) Filed: Oct. 16, 2008

(51) Int. Cl. F01D 25/12; B23P 15/02

(52) U.S. Cl. 415/115; 29/889.721

(57) ABSTRACT

A turbine engine airfoil includes an airfoil structure having a side with an exterior surface. The structure includes a cooling passage extending a length within the structure and providing a convection surface facing the side. The convection surface is twisted along the length, which varies a heat transfer rate between the exterior surface and the convection surface along the length. In one example, the cooling passage is provided by a refractory metal core that is used during the airfoil casting process. The core includes multiple legs joined by a connecting portion. At least one of the legs is twisted along its length. The legs are deformed toward one another opposite the connecting portion to provide a desired core shape that corresponds to the shape of the cooling passage. Accordingly, the cooling passage provides desired cooling of the airfoil.

### BACKGROUND

This disclosure relates to a cooling passage for an airfoil.

Turbine blades are utilized in gas turbine engines. As known, a turbine blade typically includes a platform having a root on one side and an airfoil extending from the platform opposite the root. The root is secured to a turbine rotor. Cooling circuits are formed within the airfoil to circulate cooling fluid, such as air. Typically, multiple relatively large cooling channels extend radially from the root toward a tip of the airfoil. Air flows through the channels and cools the airfoil, which is relatively hot during operation of the gas turbine engine.

Some advanced cooling designs use one or more radial cooling passages that extend from the root toward the tip. Typically, the cooling passages are arranged between the cooling channels and an exterior surface of the airfoil. The cooling passages provide extremely high convective cooling.

The Assignee of the present disclosure has discovered that in some cooling designs the airfoil is overcooled at the base of the airfoil near the platform. It is believed that strong secondary flows, particularly on the suction side, force the migration of relatively cool fluid off the end wall and onto the suction side of the blade. This results in relatively low external gas temperatures. Internally, the coolant temperature is relatively cool as it has just entered the blade. The high heat transfer coefficients provided by the cooling passage in this region are undesirable as it causes overcooling of the external surface and premature heating of the coolant air.

What is needed is a cooling passage that provides desired cooling of the airfoil.

### SUMMARY

A turbine engine airfoil is disclosed that includes an airfoil structure having a side with an exterior surface. The structure includes a cooling passage extending a length within the structure and providing a convection surface facing the side. The convection surface is twisted along the length, which varies a heat transfer rate between the exterior surface and the convection surface along the length.

In one example, the cooling passage is provided by a refractory metal core that is used during the airfoil casting process. The core includes multiple legs arranged in a fan-like shape and joined by a connecting portion. At least one of the legs is twisted along its length. The legs are deformed toward one another opposite the connecting portion to provide a desired core shape that corresponds to the shape of the cooling passage.

Accordingly, the cooling passage provides desired cooling of the airfoil by varying the cooling rate as desired.

These and other features of the disclosure can be best understood from the following specification and drawings, the following of which is a brief description.

### BRIEF DESCRIPTION OF THE DRAWINGS

FIG. 1 is a schematic view of a gas turbine engine incorporating the disclosed airfoil.

FIG. 2 is a perspective view of the airfoil having the disclosed cooling passage.

FIG. 3A is a cross-sectional view of a portion of the airfoil shown in FIG. 2 and taken along 3A-3A.

FIG. 3B is a top elevational view of the airfoil portion shown in FIG. 3A.

FIG. 3C is a bottom elevational view of the airfoil portion shown in FIG. 3A.

FIG. 4A is an elevational view of one example core structure prior to shaping the core to a desired core shape.

FIG. 4B is a partial cross-sectional view of a portion of the core structure cooperating with a second core structure, which provides a cooling channel.

FIG. 4C is a partial cross-sectional view of another portion of the core structure cooperating with the second core structure.

FIG. 4D is another embodiment illustrating a portion of the core structure cooperating with the second core structure.

FIG. 5 is a perspective view of another example airfoil having another cooling passage arrangement.

FIG. 6A is a top elevational view of another example core structure used in forming the cooling passage arrangement shown in FIG. 5.

FIG. 6B is a top elevational view of the core structure shown in FIG. 6A subsequent to twisting legs of the structure.

FIG. 6C is a top elevational view of the core structure shown in FIG. 6B subsequent to deforming the legs toward one another.

FIG. 7 is a perspective view of another example airfoil having another cooling passage arrangement.

FIG. 8A is a top elevational view of another example core structure used in forming the cooling passage arrangement shown in FIG. 7.

FIG. 8B is a top elevational view of the core structure shown in FIG. 8A subsequent to twisting and cupping legs of the structure.

FIG. 8C is a top elevational view of the core structure shown in FIG. 8B subsequent to deforming the legs toward one another.

### DETAILED DESCRIPTION

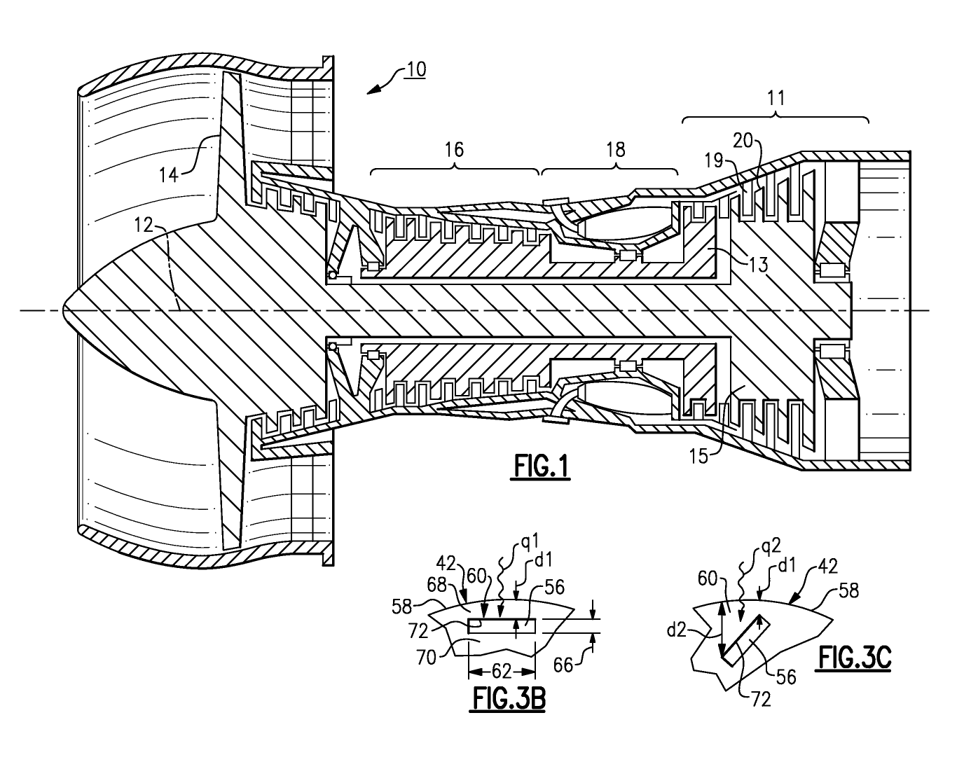

FIG. 1 schematically illustrates a gas turbine engine 10 that includes a fan 14, a compressor section 16, a combustion section 18 and a turbine section 11, which are disposed about a central axis 12. As known in the art, air compressed in the compressor section 16 is mixed with fuel that is burned in combustion section 18 and expanded in the turbine section 11. The turbine section 11 includes, for example, rotors 13 and 15 that, in response to expansion of the burned fuel, rotate, which drives the compressor section 16 and fan 14.

The turbine section 11 includes alternating rows of blades 20 and static airfoils or vanes 19. It should be understood that FIG. 1 is for illustrative purposes only and is in no way intended as a limitation on this disclosure or its application.

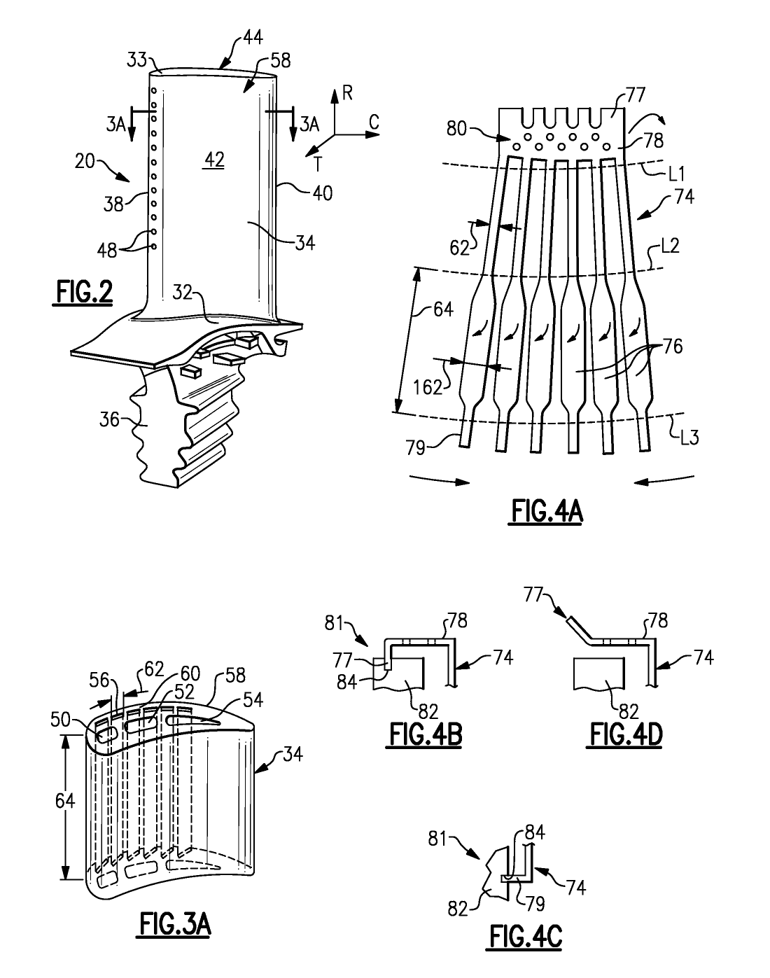

An example blade 20 is shown in FIG. 2. The blade 20 includes a platform 32 supported by a root 36, which is secured to a rotor. An airfoil 34 extends radially outwardly from the platform 32 opposite the root 36. While the airfoil 34 is disclosed as being part of a turbine blade 20, it should be understood that the disclosed airfoil can also be used as a vane.

The airfoil 34 includes an exterior surface 58 extending in a chord-wise direction C from a leading edge 38 to a trailing edge 40. The airfoil 34 extends between pressure and suction sides 42, 44 in an airfoil thickness direction T, which is generally perpendicular to the chord-wise direction C. The airfoil 34 extends from the platform 32 in a radial direction R to an end portion or tip 33. Cooling holes 48 are typically provided on the leading edge 38 and various other locations on the airfoil 34 (not shown).

Referring to FIG. 3A, multiple, relatively large radial cooling channels 50, 52, 54 are provided internally within the airfoil 34 to deliver airflow for cooling to the airfoil. The cooling channels 50, 52, 54 provide cooling air, typically from the root 36 of the blade 20.

Current advanced cooling designs incorporate supplemental cooling passages arranged between the exterior surface 58 and one or more of the cooling channels 50, 52, 54. The larger cooling channels can be omitted entirely, if desired, as shown in FIG. 5. In one disclosed example, one or more radially extending cooling passages 56 are provided in a wall 60 between the exterior surface 58 and the cooling channels 50, 52, 54 at the suction side 44. First and second wall portions 68, 70 are provided on either side of each radial cooling passage 56 respectively adjacent to the exterior surface 58 and the cooling channel 52, for example. However, it should be understood that the example cooling passages could also be provided at other locations within the airfoil.

As shown in FIG. 3A, the cooling passage 56 extends along a length 64 from the platform 32 toward the tip 33. Each cooling passage 56 includes a width 62 and a thickness 66. The width 62 is substantially greater than the thickness 66. The length 64 is substantially greater than the width 62 and the thickness 66.

Referring to FIGS. 3B and 3C, the cooling passage 56 includes a convection surface 72 having an orientation relative to the exterior surface 58 that changes along the length 64. In one example, the convection surface 72 is generally uniform in width along the length 64. The cooling passage 56 has a generally uniform rectangular cross-sectional shape in the example shown. In some applications it is desirable that the airfoil 34 have a lower heat transfer rate near the platform 32 than the tip 33.

Referring to FIG. 3B, the convection surface 72 is arranged at a distance d1 from the exterior surface 58. In the example, the exterior surface 58 and convection surface 72 are generally parallel to one another. The cross-sectional areas illustrated in FIGS. 3B and 3C are generally perpendicular to the radial direction R. The convection surface 72 has a heat transfer rate q1 at the illustrated location. The convection surface 72 is twisted along the length 64, which changes the spacing of the convection surface 72 relative to the exterior surface 58, as shown in FIG. 3C. For example, referring to FIG. 3C, one portion of the convection surface 72 is arranged the distance d1 from the exterior surface 58 while another portion of the convection surface 72 is arranged at a distance d2 from the exterior surface 58. The second distance d2 is greater than the distance d1, which results in a reduced heat transfer rate q2 relative to the heat transfer rate q1. The reduced heat transfer rate q2 results, in part, from the increased volume of the wall 60 between the cooling passage 56 and the exterior surface 58 as compared to the location illustrated in FIG. 3B.

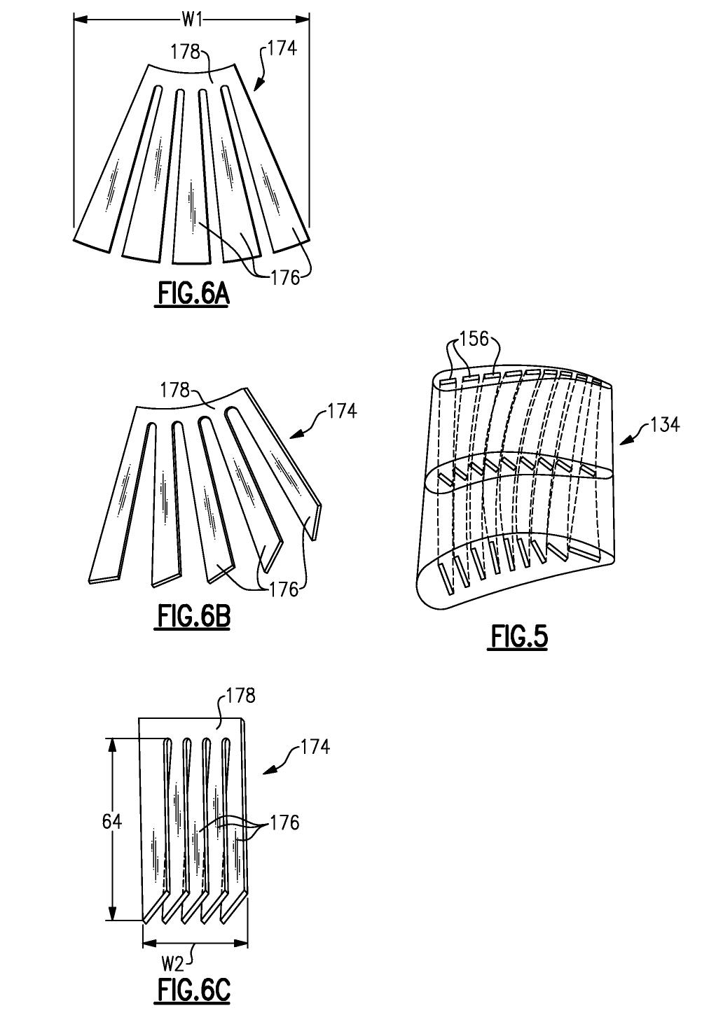

An example core structure 74 for forming the disclosed cooling passages 56 is shown in FIG. 4A. The core structure 74 includes multiple legs 76 that are joined relative to one another by a connecting portion 78. The connecting portion 78 may also be positioned outside the cast part and removed along with the rest of the core structure upon final part finishing. A portion of each leg 76 includes a taper provided by a width 162 that is greater than the width 62, which is in closer proximity to the tip 33.

The reduction in the cross-sectional area increases the Mach number as the coolant moves to the end of the cooling passage 56. The increase in Mach number in turn allows the heat transfer coefficient, h, near the exit of the cooling passage to be higher than near its inlet. This allows the designer to maintain a uniform value (or adjust to the most desirable value) based upon the product of h*A*(ΔT) resulting in a uniformly cooled blade, where h is the convection heat transfer coefficient, A is the area and ΔT is the temperature gradient. The twisting and overlapping cooling passages reduce the heat transfer coefficient and thereby reduce the heat transfer rate q going into the coolant fluid. The reduced q indicates less overcooling in regions where the twist and overlap is used.

With continuing reference to FIG. 4A, the core structure 74 is manipulated to a desired shape by folding a top portion 80 over line L1. The top portion 80 is arranged in close proximity to the tip 33 during the casting process. Portions 77 on the top portion 80 cooperate with a second core 82 to provide a core assembly 81, as shown in FIG. 4B. In one example, the core structure 74 is provided by a refractory metal material, and the second core 82 is provided by a ceramic material. The second core 82 includes a recess 84 that receives the portion 77. In this manner, the cooling passages 56 and cooling channels, 50, 52, 54 are in fluid communication with one another in the finished airfoil.

Returning to FIG. 4A, the portion of the legs 76 having the width 62 remain generally coplanar with one another while the portions of the legs 76 between the lines L2 and L3 are twisted relative to the narrower leg portions arranged between lines L1 and L2. The legs 76 include portions 79 that cooperate with the recess 84 in second core 82, as shown in FIG. 4C. Referring to FIG. 4D, the portion 77 can extend toward the tip of the airfoil and away from the second core 82 to a location outside of the airfoil. As a result, cooling passages will be provided at the tip by the portion 77 once the core structure 74 has been removed from the airfoil.

Another airfoil 134 shown in FIG. 5 includes cooling passages 156. In the example shown, the airfoil 134 does not include the larger cooling channels that are typically formed by ceramic cores. A core structure 174 that provides the cooling passages 156 is shown in FIGS. 6A-6C. The core structure 174 is stamped from a refractory metal material in a fan-like arrangement to provide multiple tapered legs 176 that are joined with a connecting portion 178. The legs 176 have an initial width W1. The legs 176 are twisted from their initial position relative to the connecting portion 178, as shown in FIG. 6B. After the legs 176 have been twisted, the legs 176 are deformed and pushed toward one another at a location opposite the connecting portion 178 to a width W2 to provide the desired core shape, which is shown in FIG. 6C.

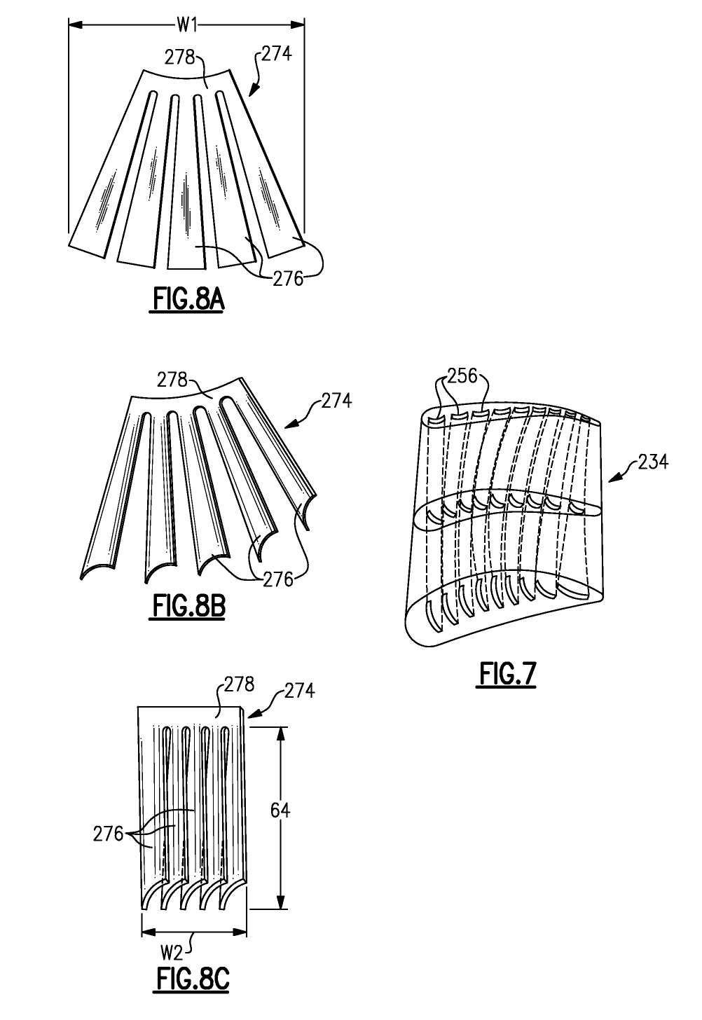

Another airfoil 234 having cooling passages 256 similar to those shown in FIG. 5 is shown in FIG. 7. In the example shown, the airfoil 234 does not include the larger cooling channels that are typically formed by ceramic cores. A core structure 274 that provides the cooling passages 256 is shown in FIGS. 8A-8C. The core structure 274 is stamped from a refractory metal material in a fan-like arrangement to provide multiple tapered legs 276 that are joined with a connecting portion 278. The legs 276 are twisted from their initial position relative to the connecting portion 278, as shown in FIG. 8B. Ends of legs 256 are cupped to provide an arcuate cross-sectional shape.

Cupping allows the designer to tailor the h*A*(ΔT) term to either side of the airfoil by changing the amount of coolant passage area that is in near proximity to the external surface 58. FIG. 7 depicts the cooling passage 56 oriented with it thickness parallel to the exterior surface 58 on the convex side. Therefore, there is roughly 50% rib and 50% cooling passage perpendicular to the exterior surface 58. On the opposite exterior surface the angled cooling passage brings much more of the passage surface area in close proximity to that exterior surface.

After the legs 276 have been twisted, the legs 276 are deformed and pushed toward one another at a location opposite the connecting portion 278 to provide the desired core shape, which is shown in FIG. 8C.

Although example embodiments have been disclosed, a worker of ordinary skill in this art would recognize that certain modifications would come within the scope of the claims. For that reason, the following claims should be studied to determine their true scope and content.

What is claimed is:

1. A turbine engine airfoil comprising:
an airfoil structure including a side having an exterior surface, the structure having a cooling passage extending a length within the structure and providing a convection surface facing the side, the convection surface twisted along the length varying a heat transfer rate between the exterior surface and the convection surface along the length.

2. The turbine engine airfoil according to claim 1, comprising a platform from which the airfoil structure extends, and a root extending from the platform opposite the airfoil.

3. The turbine engine airfoil according to claim 2, wherein the cooling passage extends in a direction from the platform to the tip.

4. The turbine engine airfoil according to claim 2, comprising a cooling channel extending along the length within the structure, the cooling passage arranged between the cooling channel and the exterior surface.

5. The turbine engine airfoil according to claim 1, wherein the cooling passage includes a generally uniform cross-sectional area along the length.

6. The turbine engine airfoil according to claim 5, wherein the cross-sectional area is generally rectangular in shape.

7. The turbine engine airfoil according to claim 1, wherein the cooling passage includes an arcuate cross-sectional shape.

8. The turbine engine airfoil according to claim 1, comprising a wall between the exterior surface and the convection surface, the wall having a greater volume away from a tip than in closer proximity to the tip.

9. The turbine engine airfoil according to claim 8, wherein the cooling passage includes a cross-sectional area perpendicular to a radial direction of the airfoil structure, the convection surface of the cross-sectional area including a first portion at a first distance from the exterior surface and a second portion at a second distance from the exterior surface, the second distance greater than the first distance.

10. The turbine engine airfoil according to claim 1, comprising multiple cooling passages interconnected by a connecting portion.

11. A turbine engine airfoil comprising:
an airfoil structure including a side having an exterior surface, the structure having a cooling passage extending a length within the structure and providing a convection surface facing the side, the cooling passage separated from the exterior surface by a wall, the convection surface having a generally uniform width, the convection surface at a first distance from the exterior surface at a first location along the length and at a second distance greater than the first distance at a second location along the length.

12. The turbine engine airfoil according to claim 11, wherein the convection surface is twisted along the length.

13. The turbine engine airfoil according to claim 11, wherein the cooling passage extends radially along the airfoil structure from a platform toward a tip.

14. The turbine engine airfoil according to claim 11, wherein the side is a suction side of the airfoil.

15. A method of manufacturing a core for use in producing an airfoil, the method comprising the steps of:
providing a core structure with multiple legs joined by a connecting portion;
twisting at least one leg along a length of the leg; and
deforming the legs toward one another opposite the connecting portion to provide a desired core shape.

16. The method according to claim 15, wherein the providing step includes stamping the core structure from a refractory metal material.

17. The method according to claim 15, wherein the core structure is fan-like arrangement having a first width in the providing step and a second width narrower than the first width subsequent to the deforming step.

18. The method according to claim 15, comprising the step of cupping the leg.

19. The method according to claim 15, comprising the step of securing a portion of the core structure to a ceramic core.
